(19) United States
(12) Patent Application Publication
(10) Pub. No.: US 2012/0254777 A1
(43) Pub. Date: Oct. 4, 2012

(54) INTERACTION METHOD, APPARATUS AND TERMINAL FOR SYNCRETIC COMMUNICATION

(75) Inventors: Yong Liu, Nanjing (CN); Fei Yang, Nanjing (CN)

(73) Assignee: Huawei Technologies Co., Ltd., Shenzhen (CN)

(21) Appl. No.: 13/434,497

(22) Filed: Mar. 29, 2012

(30) Foreign Application Priority Data
Mar. 30, 2011 (CN) 201110079003.5

(51) Int. Cl. G06F 3/048

(52) U.S. Cl. 715/762; 715/781

(57) ABSTRACT

In the field of communications technologies, an interaction method for syncretic communication is provided, which is invented for effectively improving the use experience of a user. The provided interaction method for syncretic communication includes: establish a window gadget Widget unit floatingly displayed on a main display interface, in which the Widget unit is associated with at least one virtual user in a syncretic communication unit; the Widget unit receives communication information of the virtual user associated with the Widget unit, in which the communication information is sent to the Widget unit through the syncretic communication unit; the Widget unit sends a prompt signal according to an information type of the communication information; and the Widget unit receives a response instruction of a user that is sent in response to the prompt signal, and triggers a response policy according to the response instruction.

### CROSS-REFERENCE TO RELATED APPLICATIONS

This application claims priority to Chinese Patent Application No. 201110079003.5, filed on 30 Mar. 2011, which is hereby incorporated by reference in its entirety.

### FIELD OF THE INVENTION

The present invention relates to the field of communications technologies, and in particular, to an interaction method, an apparatus and a terminal for syncretic communication.

### BACKGROUND OF THE INVENTION

The syncretic communication refers to a new communication mode which syncretizes the computer technology with the conventional communication technology, that is, syncretizes a computer network and a conventional communication network on a network platform so that numerous application services are implemented, such as phone calls, fax, data transmission, audio-video conferences, and instant messaging.

In the field of syncretic communication, for example, during communication with a contact through a PC (Personal Computer, personal computer) client, it is required to follow the contact and perform a relevant communication operation with the contact. During communication with the contact, in an existing man-machine interaction manner, a user is generally required to open a main interface of a syncretic communication client, find the contact through dragging, browsing or searching a contact a contact list, and then view information of the contact; and to open a corresponding communication operation interface, such as: QQ®, IM® (InstantMessaging, instant messaging), and Conversation, to perform a communication operation with the contact; when a new communication event occurs, the syncretic communication client will pop up a prompt dialog box, the corresponding communication on operation interface is opened after the prompt dialog box is clicked, and the communication operation interface will occupy a main display interface of the PC client.

Under the existing man-machine interaction manner, in an aspect, because the number of contacts is more and more, information amount is large, and key information is easily neglected; also, it is required to find a target contact in enormous contact list data, operations are many, and the efficiency is low; furthermore, because the communication operation interface occupies the main display interface of the user, which disturbs the user who is processing other tasks simultaneously, that is, the existing interaction manner apparently reduces the use experience of the user.

### SUMMARY OF THE INVENTION

The main object of embodiments of the present invention is to provide an interaction method, an apparatus and a terminal for syncretic communication, which can effectively improve the use experience of a user.

In order to achieve the foregoing object, the embodiments of the present invention adopt technical solutions as follows:

an interaction method for syncretic communication, including:

establishing a window gadget Widget unit floatingly displayed on a main display interface, in which the Widget unit is associated with at least one virtual user in a syncretic communication unit;

receiving, by the Widget unit, communication information of the virtual user associated with the Widget unit, in which the communication information is sent by the syncretic communication unit to the Widget unit;

sending, by the Widget unit, a prompt signal according to an information type of the communication information; and

receiving, by the Widget unit, a response instruction of a user that is sent in response to the prompt signal, and triggering a response policy according to the response instruction.

an apparatus for syncretic communication, including:

a creating unit, a Widget unit and a syncretic communication unit, in which:

the creating unit is configured to establish the Widget unit floatingly displayed on a main display interface and associated with at least one virtual user in the syncretic communication unit; and

the Widget unit is configured to receive communication information of the virtual user, associated with the Widget unit, sent by the syncretic communication unit and send a prompt signal according to an information type of the communication information; and receive a response instruction of a user that is sent in response to the prompt signal, and trigger a response policy according to the response instruction.

a terminal for syncretic communication, in which the terminal for syncretic communication is installed with the apparatus for syncretic communication provided by an embodiment of the present invention.

By adopting the technical solutions, in the interaction method for syncretic communication, the apparatus for syncretic communication and the terminal for syncretic communication provided by the embodiments of the present invention, a virtual user specified by a user, that is, a key contact may be directly displayed on a main display interface through a Widget unit, and through continuous and concentrated following and without the need of opening a main interface of a syncretic communication unit, the general trend of affairs of the key contact may be followed and a communication operation is performed with the key contact, thereby effectively reducing clicks of the interface operation, increasing the communication efficiency, and meanwhile other task operations of the user is not disturbed, so as to significantly improve the use experience of the user.

### BRIEF DESCRIPTION OF THE DRAWINGS

To illustrate the technical solutions according to the embodiments of the present invention or in the prior art more clearly, the accompanying drawings required for describing the embodiments or the prior art are introduced below briefly. Apparently, the accompanying drawings in the following descriptions merely show some of the embodiments of the present invention, and persons skilled in the related art can obtain other drawings according to the accompanying drawings without creative efforts.

FIG. 1 is a flowchart of an interaction method for syncretic communication according to an embodiment of the present invention;

FIG. 2 is a schematic diagram of a Widget unit and a syncretic communication unit in an interaction method for syncretic communication according to an embodiment of the present invention;

FIG. 3 is a schematic diagram of a visible link generated by a Widget unit in an interaction method for syncretic communication according to an embodiment of the present invention;

FIG. 4 is a schematic structural diagram of an apparatus for syncretic communication according to an embodiment of the present invention; and

FIG. 5 is a schematic structural diagram of an apparatus for syncretic communication according to an embodiment of the present invention.

### DETAILED DESCRIPTION OF THE EMBODIMENTS

The technical solutions in the embodiments of the present invention are described clearly with reference to the accompanying drawings in the embodiments of the present invention below.

It should be definite that, the described embodiments are only a part of the embodiments of the present invention, without covering all embodiments. All other embodiments obtained by persons skilled in the related art based on the embodiments of the present invention without creative efforts shall fall within the protection scope of the present invention.

It should be noted that, an interaction method for syncretic communication provided by an embodiment of the present invention is described based on an apparatus for syncretic communication installed in a terminal for syncretic communication, such as, an apparatus for syncretic communication installed in a PC client, a mobile phone, or a palmtop computer.

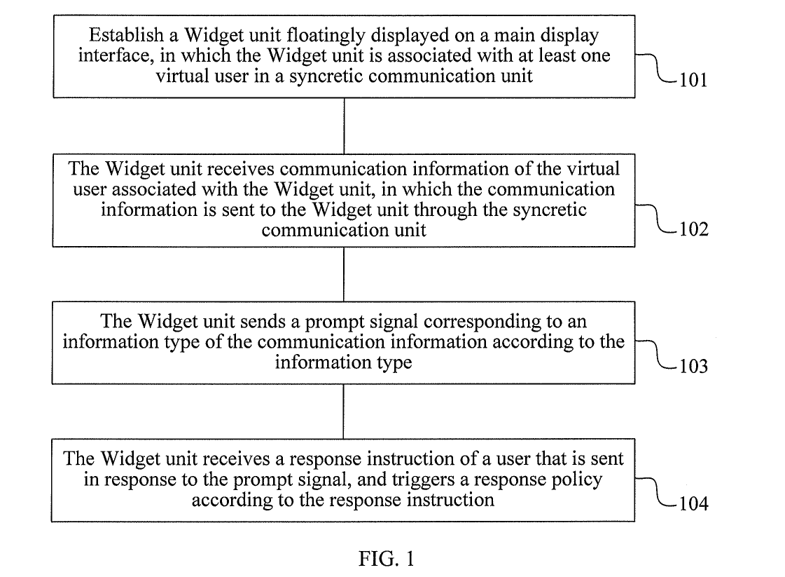

As shown in FIG. 1, an interaction method for syncretic communication provided by an embodiment of the present invention includes the following steps:

Step 101: Establish a Widget unit floatingly displayed on a main display interface, in which the Widget unit is associated with at least one virtual user in a syncretic communication unit.

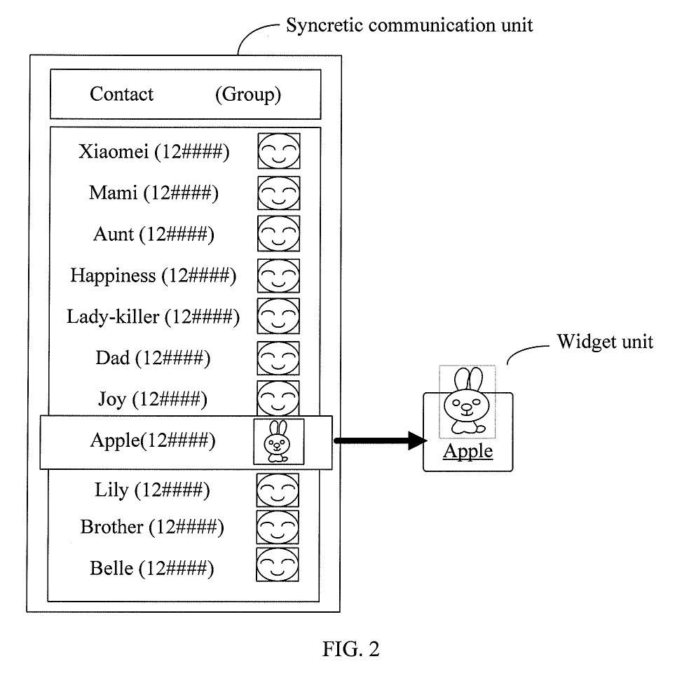

In the embodiment of the present invention, the Widget unit and the syncretic communication unit may be shown in FIG. 2. A syncretic communication unit has several virtual users, that is, has several contacts. The Widget unit is a window gadget, and is associated with at least one virtual user in the syncretic communication unit.

After the Widget unit has been established, the Widget unit is used as an input output interface between a user and a virtual user associated with the Widget unit in the syncretic communication unit, and information interaction between the user and the virtual user associated with the Widget unit in the syncretic communication unit is implemented through the Widget unit. The syncretic communication unit is a subscriber terminal which integrates a computer network with a conventional communication network on a network platform, to achieve numerous application services such as phone call, fax, data transmission, audio-video conference, call center, and instant messaging.

In an embodiment of the present invention, this step specifically includes the following steps:

Receive a Widget creation instruction, select Widget model data set in advance from a Widget model database, and establish the Widget unit according to the selected Widget model data; and

Establish an association used for performing information interaction between the Widget unit and the at least one virtual user specified by the Widget creation instruction in the syncretic communication unit. The at least one virtual user may be specified by the Widget creation instruction, or may be preset. A user may select at least one virtual user of virtual users in the syncretic communication unit, and deliver a Widget creation instruction for creating a Widget unit associated with the selected at least one virtual user, and after receiving the instruction of the user, a Widget unit associated with the selected at least one virtual user is created on a main display interface of a terminal for syncretic communication.

Alternatively, in this step, one or more Widget units floatingly displayed on the main display interface may be established, each Widget unit may be associated with one or more virtual users specified by the user in the syncretic communication unit, and the Widget unit may distinguish different virtual users through different visible features, such as a name or an avatar. Furthermore, the Widget unit may be floatingly displayed at any position of the main display interface, such as a bottom left corner or bottom right corner of the main display interface, and the area of the main display interface occupied by the Widget unit is small.

Alternatively, the Widget unit has a visible two-dimensional or three-dimensional geometrical shape, for example, the geometrical shape of the Widget unit shown in FIG. 2 includes content of a key contact, such as a name and an avatar, and the Widget unit may adopt an emotional avatar or a lifelike avatar to identify the key contact, which can apparently improve user experience.

It should be noted that, in the embodiment of the present invention, the so-called “main display interface” refers to a main screen area presented during running of the terminal for syncretic communication (such as a PC client), and is a table on which the user uses the terminal for syncretic communication for working, such as a desktop of a PC client.

A virtual user associated with a Widget unit in a syncretic communication uni t is referred to as a key contact below.

In the embodiment of the present invention, the user may search for a contact by entering a main interface of a syncretic communication unit, and performs information interaction with any contact of the syncretic communication unit. However, after a Widget unit associated with a key contact has been created, communication interaction between the user and the key contact does not need to open the main interface of the syncretic communication unit to search for the key contact, and needs to be implemented only through the Widget unit associated with the key contact. Therefore, the user is enabled to persistently follow and focus on the key contact, and may follow the general trend of affairs of the key contact and perform a communication operation with the key contact without the need of opening the main interface of the syncretic communication unit, which thereby effectively reduces interface operations such as clicking, and increases the communication efficiency. In addition, because it is not required to open the main interface of the syncretic communication unit, and the area of the main display interface occupied by the Widget unit is small, other task operations of the user are not disturbed, which thereby apparently improves the user experience.

Step 102: The Widget unit receives communication information of the virtual user associated with the Widget unit, in which the communication information is sent to the Widget unit through the syncretic communication unit.

In the embodiment of the present invention, the communication information of the virtual user associated with the Widget unit is sent to the syncretic communication unit, and sent by the syncretic communication unit to the Widget unit. That is, when the syncretic communication unit receives the communication information of the virtual user, if a Widget unit associated with the virtual user is established, the syncretic communication unit sends the communication information of the virtual user to the Widget unit associated with the virtual user, and the communication information is notified to the user through the Widget unit.

Step 103: The Widget unit sends a prompt signal according to the information type of the communication information.

The information type of the communication information may include voice call, video call, missed call, information or mail.

When the Widget unit receives the communication information of the virtual user associated with the Widget unit, in order to notify the communication information to the user in real time, the Widget unit sends the prompt signal according to the information type of the communication information.

Alternatively, the Widget unit may vary a visible feature associated with the Widget unit according to the information type of the communication information, and specifically, change a geometrical shape of the Widget unit, periodically change a display position of the Widget unit on the main display interface, shake a particular portion of the Widget unit, or vary the color of a part or the whole of the Widget unit; for example, that the outer frame of an avatar included in the Widget unit turns red denotes a missed call, and that a contact avatar in the Widget unit is being shaken denotes an ongoing call.

Alternatively, the Widget unit may further emit an acoustic feature associated with the Widget unit according to the information type of the communication information, and specifically, send sound prompts corresponding to different information types.

Apparently, the Widget unit may further vary a visible feature associated with the Widget unit according to the information type of the communication information, and simultaneously emit an acoustic feature associated with the Widget unit.

Alternatively, the Widget unit may further directly use a corresponding icon or character to display the communication information according to the information type of the communication information.

Step 104: The Widget unit receives a response instruction of a user that is sent in response to the prompt signal, and triggers a response policy according to the response instruction.

When the user receives or learns, through the Widget unit, the communication information of the virtual user associated with the Widget unit, the user delivers a response instruction through the Widget unit, and in this case, the Widget unit triggers a response policy according to the response instruction.

The response policy is a manner of an operation executed by the Widget unit according to the response instruction of the user, which includes suspending the prompt signal sent by the Widget unit, disabling the Widget unit, enabling communication of the virtual user associated with the Widget unit, modifying a user state or updating user information, in which, alternatively, the communication of the virtual user associated with the Widget unit includes: fixed conversation, mobile conversation, instant messaging, E-mail, video conversation or multi-party conversation, and the user state may include real-time states of the user such as busy, left, and idle, and may be modified in real time according to the response instruction of the user. The user information may include a signature of the user and identity data of the user, and likewise, may be updated in real time according to a corresponding instruction.

For example, the Widget unit dials a mobile phone or fixed phone of a virtual user associated with the Widget unit, sends a short message to the virtual user associated with the Widget unit, initiates chatting with the virtual user associated with the Widget unit, or disables the Widget unit according to the response instruction.

Specifically, in this step, the Widget unit may suspend the prompt signal sent by the Widget unit according to the response instruction, and generate a graphical reply window by which the user communicates with the virtual user, such as, generate an information input window of an E-mail or IM information.

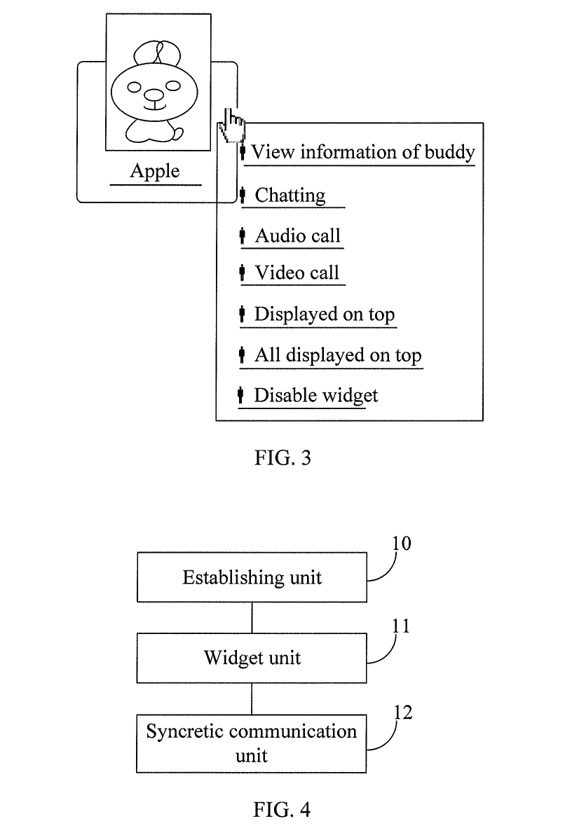

Further, before the Widget unit triggers the response policy according to the response instruction, as shown in FIG. 3, the Widget unit may generate a visible link option between the Widget unit and a response policy which the virtual user associated with the Widget unit may execute, then, trigger the response policy selected by the user by receiving the visible link option selected by the user.

Specifically, in this step, the Widget unit may receive a first response instruction of the user, and generate and display a visible link between the Widget unit and a response policy which the virtual user associated with the Widget unit may execute, in which, the visible link option may be displayed through a character, or may be displayed through an icon, or may be further displayed through an icon and a character simultaneously; and next, trigger the response policy selected by the user, that is, execute the response policy by receiving a second response instruction of the visible link option selected by the user.

Alternatively, the response instruction of the user may be delivered by the user in such manners as a mouse, a keyboard, and a gesture, for example, the user clicks a contact avatar in the Widget unit through a mouse.

It should be noted that, the Widget unit enables communication of the virtual user associated with the Widget unit through the syncretic communication unit. In the embodiment of the present invention, the Widget unit is used as an input output interface between a user and a virtual user associated with the Widget unit in the syncretic communication unit, while substantially, the communication information between the user and the virtual user associated with the Widget unit is interacted between the syncretic communication unit and a network side, the syncretic communication unit receives the communication information, sent by the network side, of the virtual user associated with the Widget unit, sends the communication information of the virtual user associated with the Widget unit to the Widget unit, outputs the communication information to the user through the Widget unit, and sends the communication information of the user input through the Widget unit to the virtual user associated with the Widget unit of the network side.

In the interaction method for syncretic communication provided by the embodiment of the present invention, a virtual user in a syncretic communication unit specified by a user, that is, a key contact may be directly displayed on a main display interface through a Widget unit, and through continuous and concentrated following and without the need of opening a main interface of the syncretic communication unit, the general trend of affairs of the key contact may be followed and a communication operation is performed with the key contact, thereby effectively reducing click of the interface operation, increasing the communication efficiency, and meanwhile other task operations of the user is not disturbed, so as to apparently improve the use experience of the user.

Corresponding to the interaction method for syncretic communication, an embodiment of the present invention further provides an apparatus for syncretic communication, as shown in FIG. 4, which includes:

a creating unit 10, a Widget unit 11 and a syncretic communication unit 12.

The creating unit 10 is configured to create the Widget unit 11 floatingly displayed on a main display interface and associated with at least one virtual user in the syncretic communication unit 12.

The Widget unit 11 is configured to receive communication information of the virtual user, associated with the Widget unit 11, sent by the syncretic communication unit 12 and send a prompt signal according to an information type of the communication information; and receive a response instruction of a user that is sent in response to the prompt signal, and trigger a response policy according to the response instruction.

It should be noted that, in the embodiment of the present invention, the so-called “main display interface” refers to a main screen area of the terminal for syncretic communication (such as a PC client) installed with the apparatus for syncretic communication provided by the embodiment of the present invention during running, and is a plane on which the user uses the terminal for syncretic communication for working.

In the apparatus for syncretic communication provided by the embodiment of the present invention, a syncretic communication unit may directly display a virtual user specified by a user on a main display interface as a Widget unit which is followed and focused on continuously, where the virtual user is a key contact. This allows the user to follow the general trend of affairs of the key contact without the need of opening a main interface of the syncretic communication unit, and communicate with the key contact, thereby effectively reducing clicks of the interface operation, increasing the communication efficiency. In addition, other task operations of the user is not disturbed, so as to apparently improve the use experience of the user.

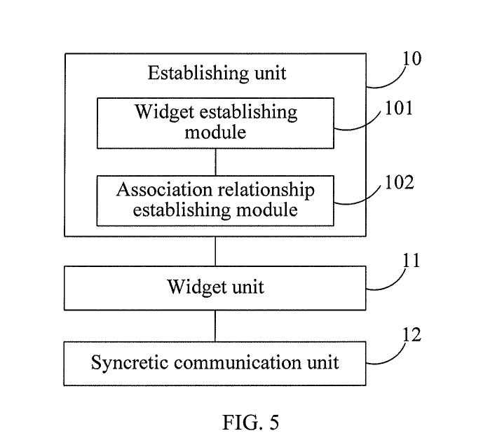

Specifically, in an embodiment of the present invention, as shown in FIG. 5, a creating unit 10 may include:

a Widget creating module 101, configured to receive a Widget creation instruction, select Widget model data set in advance from a Widget model database, and establish a Widget unit 11 according to the selected Widget model data; and

an association creating module 102, configured to establish an association used for performing information interaction between the Widget unit 11 and the at least one virtual user in a syncretic communication unit 12.

Alternatively, the Widget unit 11 may be specifically configured to vary a visible feature associated with the Widget unit 11 according to the information type of the communication information, which specifically includes: changing a geometrical shape of the Widget unit 11, periodically changing a display position of the Widget unit 11 on the main display interface, shaking a particular portion of the Widget unit 11, or varying the color of a part or the whole of the Widget unit 11.

Alternatively, the Widget unit 11 may be further specifically configured to emit an acoustic feature associated with the Widget unit 11 according to the information type of the communication information.

Alternatively, the Widget unit 11 may be further specifically configured to vary a visible feature associated with the Widget unit 11 according to the information type of the communication information, and emit an acoustic feature associated with the Widget unit 11 simultaneously.

Specifically, the response policy triggered by the Widget unit 11 includes: suspending the prompt signal sent by the Widget unit 11, disabling the Widget unit, enabling communication of the virtual user associated with the Widget unit 11, modifying a user state or updating user information. The communication, enabled by the Widget unit 11, of the virtual user associated with the Widget unit 11 includes: fixed conversation, mobile conversation, instant messaging, E-mail, video conversation or multi-party conversation.

Alternatively, the Widget unit 11 may be specifically configured to suspend the prompt signal sent by the Widget unit 11 according to the response instruction, and generate a graphical reply window for the user to communicate with the virtual user.

Further, before the Widget unit 11 triggers the response policy according to the response instruction, the Widget unit 11 is further configured to generate a visible link between the response policy and the Widget unit 11.

For specific working methods of components of the apparatus for syncretic communication provided by the embodiment of the present invention, reference may be made to the method embodiment of the present invention.

Accordingly, an embodiment of the present invention further provides a terminal for syncretic communication, in which the terminal for syncretic communication is installed with the apparatus for syncretic communication provided by an embodiment of the present invention.

In the terminal for syncretic communication provided by the embodiment of the present invention, a virtual user in a syncretic communication unit specified by a user, that is, a key contact may be directly displayed on a main display interface through a Widget unit, and through continuous and concentrated following and without the need of opening a main interface of the syncretic communication unit, the general trend of affairs of the key contact may be followed and a communication operation is performed with the key contact, thereby effectively reducing click of the interface operation, increasing the communication efficiency, and meanwhile other task operations of the user is not disturbed, so as to apparently improve the use experience of the user.

The terminal for syncretic communication provided by the embodiment of the present invention may be a PC client, a mobile phone, or a palmtop computer.

Persons skilled in the art may understand that all or part of the processes of the method according to the embodiments may be implemented by a computer program instructing relevant hardware. The program may be stored in a computer readable storage medium. When the program is executed, the steps of the method according to the embodiments are performed. The storage medium may be any medium that is capable of storing program codes, such as an ROM, an RAM, a magnetic disk, or an optical disk.

The above is only the specific implementation of the present invention, but the protection scope of the present invention is not limited thereto. Any change or replacement that can be easily figured out by persons skilled in the art within the technical scope disclosed by the present invention shall be covered by the protection scope of the present invention. Therefore, the protection scope of the present invention is subject to the appended claims.

What is claimed is:

1. An interaction method for syncretic communication, comprising:
establishing a window gadget, Widget unit, floatingly displayed on a main display interface, wherein the Widget unit is associated with at least one virtual user in a syncretic communication unit;
receiving, by the Widget unit, communication information of the virtual user associated with the Widget unit, wherein the communication information is sent by the syncretic communication unit to the Widget unit;
sending, by the Widget unit, a prompt signal according to the information type of the communication information; and
receiving, by the Widget unit, a response instruction of a user that is sent in response to the prompt signal, and triggering a response policy according to the response instruction.

2. The interaction method according to claim 1, wherein the triggering the response policy according to the response instruction comprises:
suspending the prompt signal sent by the Widget unit according to the response instruction, and generating a graphical reply window for the user to communicate with the virtual user.

3. The interaction method according to claim 1, wherein the establishing the Widget unit floatingly displayed on the main display interface comprises:
receiving a Widget creation instruction, selecting Widget model data set in advance from a Widget model database, and creating the Widget unit according to the selected Widget model data; and
establishing an association used for performing information interaction between the Widget unit and the at least one virtual user in the syncretic communication unit.

4. The interaction method according to claim 1, wherein the sending, by the Widget unit, the prompt signal according to the information type of the communication information comprises:
varying, by the Widget unit, a visible feature associated with the Widget unit according to the information type of the communication information, or emitting an acoustic feature associated with the Widget unit, or varying the visible feature associated with the Widget unit and simultaneously emitting the acoustic feature associated with the Widget unit.

5. The interaction method according to claim 4, wherein the varying the visible feature associated with the Widget unit comprises: changing a geometrical shape of the Widget unit, periodically changing a display position of the Widget unit on the main display interface, shaking a particular portion of the Widget unit, or varying a color of a part or the whole of the Widget unit.

6. The interaction method according to claim 1, wherein before the triggering the response policy according to the response instruction, the method further comprises:
generating a visible link between the response policy and the Widget unit.

7. The interaction method according to claim 1, wherein
the response policy comprises: suspending the prompt signal sent by the Widget unit, disabling the Widget unit, enabling communication of the virtual user associated with the Widget unit, modifying a user state or updating user information.

8. The interaction method according to claim 7, wherein
the communication of the virtual user associated with the Widget unit comprises: fixed conversation, mobile conversation, instant messaging, E-mail, video conversation or multi-party conversation.

9. An apparatus for syncretic communication, comprising:
a creating unit, a Widget unit, and a syncretic communication unit, wherein:
the creating unit is configured to create the Widget unit floatingly displayed on a main display interface and associated with at least one virtual user in the syncretic communication unit; and
the Widget unit is configured to receive communication information of the virtual user, associated with the Widget unit, sent by the syncretic communication unit and send a prompt signal according to the information type of the communication information; and receive a response instruction of a user that is sent in response to the prompt signal, and trigger a response policy according to the response instruction.

10. The apparatus for syncretic communication according to claim 9, wherein
the Widget unit is configured to suspend the prompt signal sent by the Widget unit according to the response instruction, and generate a graphical reply window for the user to communicate with the virtual user.

11. The apparatus for syncretic communication according to claim 9, wherein
the creating unit comprises:
a Widget creating module, configured to receive a Widget creation instruction, select Widget model data set in advance from a Widget model database, and creating the Widget unit according to the selected Widget model data; and
an association creating module, configured to establish an association used for performing information interaction between the Widget unit and the at least one virtual user in the syncretic communication unit.

12. The apparatus for syncretic communication according to claim 9, wherein
the Widget unit is configured to vary a visible feature associated with the Widget unit according to the information type of the communication information, or emit an acoustic feature associated with the Widget unit, or vary the visible feature associated with the Widget unit and simultaneously emit the acoustic feature associated with the Widget unit.

13. The apparatus for syncretic communication according to claim 12, wherein
that the Widget unit varies the visible feature associated with the Widget unit comprises:
changing a geometrical shape of the Widget unit, periodically changing a display position of the Widget unit on the main display interface, shaking a particular portion of the Widget unit, or varying a color of a part or the whole of the Widget unit.

14. The apparatus for syncretic communication according to claim 9, wherein
before the Widget unit triggers the response policy according to the response instruction, the Widget unit is further configured to generate a visible link between the response policy and the Widget unit.

15. The apparatus for syncretic communication according to claim 9, wherein the response policy triggered by the Widget unit comprises:
suspending the prompt signal sent by the Widget unit, disabling the Widget unit, enabling communication of the virtual user associated with the Widget unit, modifying a user state or updating user information.

16. The apparatus for syncretic communication according to claim 15, wherein the communication, enabled by the Widget unit, of the virtual user associated with the Widget unit comprises: fixed conversation, mobile conversation, instant messaging, E-mail, video conversation or multi-party conversation.

17. A terminal for syncretic communication, wherein the terminal for syncretic communication is installed with the apparatus for syncretic communication according to the claim 9.
